(19) United States
(12) Patent Application Publication
(10) Pub. No.: US 2003/0134614 A1
(43) Pub. Date: Jul. 17, 2003

(54) Mobile virtual network operator platform and method of and system for using same

(76) Inventor: Stephen M. Dye, Coral Springs, FL (US)

Correspondence Address: EDWARDS & ANGELL, LLP, P.O. BOX 9169, BOSTON, MA, 02209, US

(21) Appl. No.: 10/044,834

(22) Filed: Jan. 11, 2002

(51) Int. Cl. H04Q 7/20

(52) U.S. Cl. 455/406; 455/413; 455/517

(57) ABSTRACT

The invention provides a mobile virtual network operator platform that enables users of wireless personal communication system networks to communicate with one or more wireless application operators irregardless of the air interface access technique used by the personal communication system network and irregardless of the wireless network. Furthermore, the invention includes methods of and a system for providing users of wireless personal communication system networks with multiple wireless applications from one or more wireless application operators irregardless of the air interface access technique used by the personal communication system network and irregardless of the wireless network. The mobile virtual network operator platform is a proxy server that comprises a short message service center and an application aggregation device. The short message service center interface enables the network operator platform to communicate with the one or more personal communication system carriers that are using one or more air interface access techniques. The application aggregation device enables the network operator platform to communicate with multiple wireless application operators, which enables the network operator platform to provide multiple wireless data applications to remote users of the various personal communications systems.

### BACKGROUND OF THE INVENTION

1. Field of the Invention

The present invention relates to telecommunication system architectures and methods of providing telecommunication services between one or more remote units and a central location, and, more particularly to systems and methods that include a universal virtual carrier or “mobile virtual network operator” to enable one or more personal communication system networks and users thereof to communicate with one or more wireless application operators irrespective of the air interface protocol used by the personal communication system and/or the wireless network used by wireless application operators.

2. Description of the Related Art

Wireless communications, which can provide virtually immediate access to voice telephone services and/or data at practically any location and at practically any time, are well established throughout the United States and much of the rest of the world. Presently, a common, and possibly the most common, wireless communication application comprises a cellular telephone network. Cellular telephone networks operate much like traditional, i.e., “wireline”, telephone services, essentially substituting radio frequencies for telephone wires. Indeed, cellular telephone networks enable a large number of transceivers, e.g., portable/mobile/transportable wireless devices, to communicate via a base station or satellite, which is favorably situated to provide coverage in a geographical cell.

Typically, cellular telephone networks include a plurality of portable/mobile/transportable wireless devices, e.g., telephone units, a plurality of contiguous cell sites, a Mobile Telephone Switching Center (MTSC), and all necessary system interconnections. The wireless devices, which, typically, can be hand-held or vehicle-mounted, communicate by radio frequency with a base station in each cell. Each base station includes one or more radio transceivers and a control unit. The radio transceivers transmit and receive control and usage signals between the MTSC and the telephone units. The MTSC, in turn, controls the switching between cell sites and the wireline Public Switched Telephone Network (PSTN).

In one exemplary application, the MTSC receives a call directed to a discrete mobile telephone unit from the PSTN. The MTSC deciphers the mobile telephone unit address and signals the appropriate cell control unit. The cell control unit then pages the discrete mobile telephone unit addressee. More specifically, the radio transceiver, which operates at the same frequency(ies) as the mobile telephone units in its cell, transmits control data to the discrete mobile telephone unit alerting it that the MTSC is sending it a call. Moreover, the control unit typically alerts the mobile telephone unit as to which user, or voice, channel the call has been assigned. The radio transceiver then relays the call to the mobile telephone unit over the identified user channel.

In another application, mobile telephone units transmit control data to the control unit of a cell, alerting the control unit that the mobile telephone unit wants to place a call directed to a discrete telephone number on the PSTN, e.g., by radio-wire-interface, or to another mobile telephone unit in the same or another cell. The cell control unit transmits the data to the MTSC. The MTSC deciphers the desired telephone number and dials the number over the PSTN; or, alternately, the MTSC deciphers the mobile telephone unit address and signals the appropriate cell control unit as described above.

A problem with current wireless communications, however, is that air interface standards, e.g., access schemes, between base stations and telephone units are not universally applied. Indeed, the more common access schemes include, inter alia, Global Standards for Mobile Communications (GSM), Time Division Multiplexing Access (TDMA), Frequency Division Multiplexing Access (FDMA), Coded Division Multiplexing Access (CDMA), and integrated digital enhanced network (iDEN) techniques. The function of each air interface standard, however, is to facilitate communications in a multiple access environment efficiently. More precisely, the purpose of the access technique is to provide simultaneous telecommunication service to multiple users without interference, i.e., collisions whereby simultaneous transmissions in a cell “collide” with each other.

TDMA techniques represent a carry-over from wireline applications. Just as speech signals from a plurality of lines are encoded, combined, and transmitted in a series of frames over a wireline, TDMA techniques divide multiple signals temporally for broadcast over a single radio frequency (RF) channel during a pre-established time interval. Indeed, with TDMA, each time interval contains a series of smaller time frames, or slots, which are separated temporally. Each of the time slots contains data from a single caller to a single telephone unit. Thus, each transmission is isolated from adjacent transmissions, which prevents collision.

By comparison, FDMA techniques assign different frequency slots to each transmission. Accordingly, communication between a base station and a mobile telephone unit is substantially continuous instead of comprising a series of time frames. Moreover, each transmission is confined to a discrete frequency, which separates multiple transmissions to prevent collision.

Furthermore, in contrast, CDMA techniques simultaneously transmit a plurality of encoded signals over a common spectrum band, which signals can be interpreted only if the transceiver and mobile telephone unit are properly encrypted. Accordingly, transmissions are not isolated temporally from adjacent transmissions as with TDMA or confined to a separate frequency as with FDMA.

These various techniques as well as others not described herein but well-known to the art are incompatible with one another insofar as a transceiver designed for a TDMA interface cannot communicate intelligently with a telephone unit designed for either a FDMA or a CDMA interface and vice versa. This lack of uniformity or standardization poses a serious problem for those trying to further standardize wireless communication.

Furthermore, personal communication networks and, more particularly, personal communication systems (PCS) offer wireless communication access in a similar fashion to the cellular telephone network; however, the services generally are provided in a single cell, or over a limited geographical area. Inventions, such as disclosed in U.S. Pat. No. 5,457,736 to Cain, et al., have dealt with handover functionality, which allows the PCS to expand its geographical borders. Indeed, the patent to Cain, et al. discloses a system including a Distributed Radio Port Controller architecture, comprising a plurality of radio port controllers that are interconnected by voice and signal circuits that control a plurality of radio ports, each port having a corresponding geographical coverage area.

The telecommunications industry exhibits increasing interest in wireless communication systems that communicate data, i.e., “non-speech”, and/or voice, i.e., “speech”, between a plurality of remote sites and/or between a remote site and a central location. Indeed, throughout the United States and much of the rest of the world, voice and data communications are transmitted over existing wireline and wireless communication networks. However, in the competitive, fast-changing telecommunications industry, service providers typically offer their customers either “voice” services or “data” services, but generally not both. For example, Personal Communication Services (PCS) carriers, e.g., cellular phone companies, are voice-centric, providing a plethora of bi-directional, digital, voice-based services but having little or nothing to offer with respect to data transmission. Wireless application providers, e.g., beepers, pagers, personal digital assistants (PDA's), short message services (SMS), and the like, on the other hand, provide textual data to customers through one or more analog applications, but little or no voice. Given the vast capability of existing telecommunication networks and telecommunication equipment to transmit and receive both voice and data over existing networks, it remains a mystery that PCS carriers and wireless providers are not motivated to effect a crossover to the other dimension.

Wireless application operators, in most instances, would prefer using a PCS network for delivery of data streams. Indeed, PCS networks are digital; far more secure; and have a greater coverage area.

A possible explanation as to why PCS carriers have not formed strategic alliances with wireless application operators may be because wireless application operators generally provide only a limited number of applications. Consequently, although there are countless wireless applications made available to consumers, there is no single source for all possible wireless applications. Furthermore, this condition is exacerbated by wireless application providers using a myriad of alternative and/or proprietary wireless networks, e.g., RAM, ARDIS, MOBITEX, CPDP, and ReFLEX to name just a few. Consequently, selecting a single wireless application operator or the “wrong” wireless application operator can be restrictive, can alienate customers, and can impact client base and revenue.

Such an alliance between PCS carriers and wireless application operators also would require PCS carriers to perform at least one of the following: (i) retrain sales force; (ii) educate or re-educate customer base; (iii) undertake new marketing campaigns; (iv) require new billing procedures; (v) design and manufacture a new line of telecommunication devices; and/or (vi) require additional network resources to handle additional traffic. Indeed, the frequency of some wireless applications is estimated at about once every 8 or 10 seconds, whereas the frequency of most voice applications is far greater.

Furthermore, voice-based PCS networks tend to be digital, which makes accommodating the next generation of devices easier. Wireless application operators, however, prefer analog devices, which, in most cases, must be completely re-designed as technology advances to another generation.

Therefore, it would be desirable to provide a virtual carrier, e.g., a mobile virtual network operator, that enables a plurality of wireless application operators to communicate and/or interface with a plurality of PCS carriers irregardless of the protocol techniques used by any of the wireless application operators and/or the PCS carriers.

Furthermore, it would be desirable to provide a method and a system for aggregating a number of wireless application operators, which offer fewer than all available data applications and which, further, operate on one or more unique networks, into a single platform that can interface with one or more PCS carriers, which carriers operate using one or more air interface protocols.

### SUMMARY OF THE INVENTION

The present invention provides a method and a system that allows wireless application operators to offer their customers both short message service (SMS) and bi-directional data transmission applications.

Furthermore, preferred embodiments of the present invention provide a method and a system for providing bi-directional voice and data transmissions that are compatible with all wireless application operators and all wireless standards.

Additionally, certain embodiments of the present invention provide a method and system for providing wireless application operators with reliable SMS and bi-directional data transmission applications at low cost.

Furthermore, other embodiments of the present invention provide a method and system for providing wireless application operators with SMS and bi-directional data transmission applications using current and future, e.g., 2.5G/3G, PCS/cellular technologies.

According to one embodiment of the present invention, the invention provides:

a mobile virtual network operator platform for interfacing a plurality of wireless applications from one or more wireless application operators with one or more personal communication system carriers, the network operator platform comprising:

a short message service center interface that enables the network operator platform to communicate with the one or more personal communication system carriers through one or more short message service centers using one or more air interface access techniques; and

an application aggregation device that enables the network operator platform to communicate with said one or more wireless application operators, further enabling the network operator platform to provide one or more wireless applications to a plurality of remote user units through one or more personal communication systems.

According to another embodiment of the present invention, the invention provides:

a system for interfacing one or more personal communication systems, which operate using one or more air interface protocols carriers, with a plurality of wireless applications from one or more wireless application operators, the system comprising:

a network, having a plurality of system interconnections; and

a mobile virtual network operator platform.

According to yet another embodiment of the present invention, the invention provides:

a method of interfacing a plurality of wireless applications from one or more wireless application operators with one or more personal communication system carriers, the method comprising the steps of:

providing a mobile virtual network operator platform;

providing a short message service center interface that enables the virtual network operator platform to communicate with the one or more personal communication system carriers through one or more short message service centers using one or more air interface access techniques; and

providing an application aggregation device that enables the virtual network operator platform to communicate with one or more wireless application operators, enabling the virtual network operator platform to provide one or more wireless applications to a plurality of remote user units.

According to yet another embodiment of the present invention, the invention provides:

a method of interfacing a plurality of wireless applications from one or more wireless application operators with one or more remote users of one or more personal communication systems, the method comprising the steps of:

providing a virtual mobile network operator platform;

providing a short message service center interface that enables said virtual network operator platform to communicate with one or more remote users of one or more personal communication systems through one or more short message service centers using one or more air interface access techniques; and

providing an application aggregation device that enables said virtual network operator platform to communicate with one or more wireless application operators, enabling the network operator platform to provide one or more wireless applications to one or more remote users of said one or more personal communication systems.

### BRIEF DESCRIPTION OF THE DRAWINGS

For a fuller understanding of the nature and advantages of the present invention, reference is made to the following detailed description and the accompanying drawings. In the drawings, like reference characters denote corresponding parts throughout the several views.

FIG. 1 provides an illustrative diagram of one embodiment of a system in accordance with the present invention;

FIG. 2 provides an illustrative diagram of one embodiment of a mobile virtual network operator platform; and

FIG. 3 provides an illustrative flow chart of one embodiment of a method of providing a plurality of wireless applications to users of one or more PCS carriers in accordance with the present invention.

### DETAILED DESCRIPTION OF THE INVENTION AND PREFERRED EMBODIMENTS THEREOF

The system of the present invention will be described in greater detail with reference to the drawings. FIG. 1 illustrates one embodiment of the present invention, which is shown for illustrative purposes only and is not to be taken or construed as being limited thereto. The system 10 of the present invention comprises the combination of a wireless communication network 20, a short message service center (SMSC) 30, a plurality of data-based applications 40, a mobile virtual network operator (MVNO) platform, i.e., proxy server, 50, and a plurality of system interconnections 60. Peripheral to the system 10 can be at least one of the following: a plurality, or, more preferably, a multiplicity, of telemetry units 22, a plurality, or, more preferably, a multiplicity, of telematic units 24, a plurality, or, more preferably, a multiplicity, of wireless (telephone) devices 26; one or more databases 80, and a public switched telephone network (PSTN) 70.

Preferably, the wireless communication network 20 is of a type that is well known to the art. Indeed, in a preferred embodiment of the present invention, the network 20 of the present invention can include one or more existing, subscriber-based, wireless carrier communication networks, e.g., PCS networks, that use any of the air interface access techniques described above, e.g., GSM, TDMA, FDMA, CDMA, iDEN and the like, which can include proprietary protocols such as Parlay, SMPP, UCP, OIS, CIMD, and the like. Alternately, the network 20 can include a unique communication network 20 that has been established expressly for this application.

Preferably, the wireless communication network 20 communicates with a plurality, or, more preferably, a multiplicity, of remote users 22, 24 and 26, which transmit one or more types of information, e.g., voice, binary data, and the like. Examples of remote user types include, inter alia, telemetry units 22, telematic units 24, and wireless devices 26. Telemetry units 22, typically, are configured and arranged to transmit raw data, e.g., utility meter readings, in a binary format to a remote data collection unit either on request, e.g., in response to SMSC 30 messaging, or at a prescribed date and/or time. Telematic units 24, e.g., personal digital assistants (PDAs), pagers, beepers, and the like, typically are configured and arranged to provide any one of a variety of wireless application services. Wireless devices 26, typically, are configured and arranged to support bi-directional transmission of voice and data communications. The means and methods of transmitting binary data by telemetric and telematic units 22 and 24 and transmitting voice and data communications by wireless devices 26 are well known to the art and will not be described further herein.

The wireless communication network 20 of the present invention further includes a plurality of contiguous cells that cover a defined geographical area. Cellular networks are well known to the art and will not be described in detail herein. Each cell of the network 20 includes one or more base stations (not shown), which are integrally connected to one or more Mobile Telephone Switching Centers (MTSC) (not shown). Base stations typically include a combination of one or more antennae and one or more transceivers, which combination is used to transmit data to and receive data from remote users 22, 24 and 26, and transmission equipment, which enables the base station to communicate with the MTSC.

The MTSC, which essentially comprises a microprocessor with memory that can perform simple and intricate switching or routing functions, is configured and arranged to communicate with and through the Public Switched Telephone Network (PSTN) 70 or other equivalent telephone network for the purpose of transmitting and receiving “calls” between a remote user 22, 24 and 26 and a wireline user (not shown) and/or between remote users 22, 24 and 26. Preferably, the MTSC provides an interface between the base station(s) of the PCS network(s)and the PSTN 70. More preferably, the MTSC also provides a means for generating billing records, e.g., a database containing user identification and amount (time) of usage, for each call.

For example, for a call between remote users 22, 24 and 26 that can be located in the same or remote cells, the calling or initiating remote user 22, 24 and 26 sends data to the cell base station, whence it is transmitted to the MTSC. The MTSC receives the data; ascertains to whom the data is to be sent and the location, i.e., cell, of the receiving remote user 22, 24 and 26; and returns the data and identification of the receiving remote user 22, 24 and 26 to the appropriate base station that services the cell in which the receiving remote user 22, 24 and 26 is located. The base station of the appropriate cell then transmits the data to the appropriate receiving remote user 22, 24 and 26. Calls between a remote user 22, 24 and 26 and a wireline user are similar. The calling or initiating remote user 22, 24 and 26 sends data to the base station, whence it is transmitted to the MTSC. The MTSC receives the data; ascertains to whom the data is to be sent; and returns the data and identification of the wireline user to the PSTN 70. The PSTN 70 then transmits the data over a local or long distance wireline through a radio-wire interface.

Preferably, the MTSC also is configured and arranged to communicate with the SMSC 30 so that data from remote users 22, 24 and 26 and/or from wireline users can be routed to the SMSC 30 for retransmission. The Short Message Service Center (SMSC) 30 of the present invention is a routing device of a type that is well known in the art. The SMSC 30, which likewise comprises a microprocessor and memory, functions as a clearing house and depository for receiving, delivering, and temporarily storing short message service data between remote users 22, 24 and 26 and/or a remote user 22, 24 and 26 and, e.g., a wireless application server. Preferably, the SMSC 30 is configured and arranged to communicate textual and binary messages to remote users 22, 24, and 26 without establishing a circuit, or call, connection therebetween.

For example, for a call between remote users 22, 24 and 26, the calling or initiating remote user 22, 24 and 26 sends data to the base station, whence the data are transmitted to the MTSC. The MTSC receives the data; ascertains to whom the data are to be sent and where they are located; and returns the data and identification of the receiving remote user 22, 24 and 26 to the appropriate base station. The base station then transmits the data to the appropriate receiving remote user 22, 24 and 26. However, in the event that delivery of data to the appropriate receiving remote user 22, 24 and 26 is unsuccessful, data are, instead, transmitted to the SMSC 30 for storage in memory, e.g., RAM, provided therefore, whence the data can be accessed by or forwarded to the appropriate receiving remote user 22, 24 and 26 at a later date and/or time when the remote user 22, 24 and 26 is available.

The SMSC 30, further, is configured and arranged to facilitate communication with the MVNO platform 50. Preferably, the MVNO platform 50 is a proxy server that operates between a client-server arrangement to filter requests from the client application and improve the overall performance. For example, a proxy server would “sit” between a client application, e.g., a Web browser, and a server, e.g., a Web site server. The proxy server intercepts requests from the client application and ascertains whether or not it can fulfill the request without passing the request on to the true server.

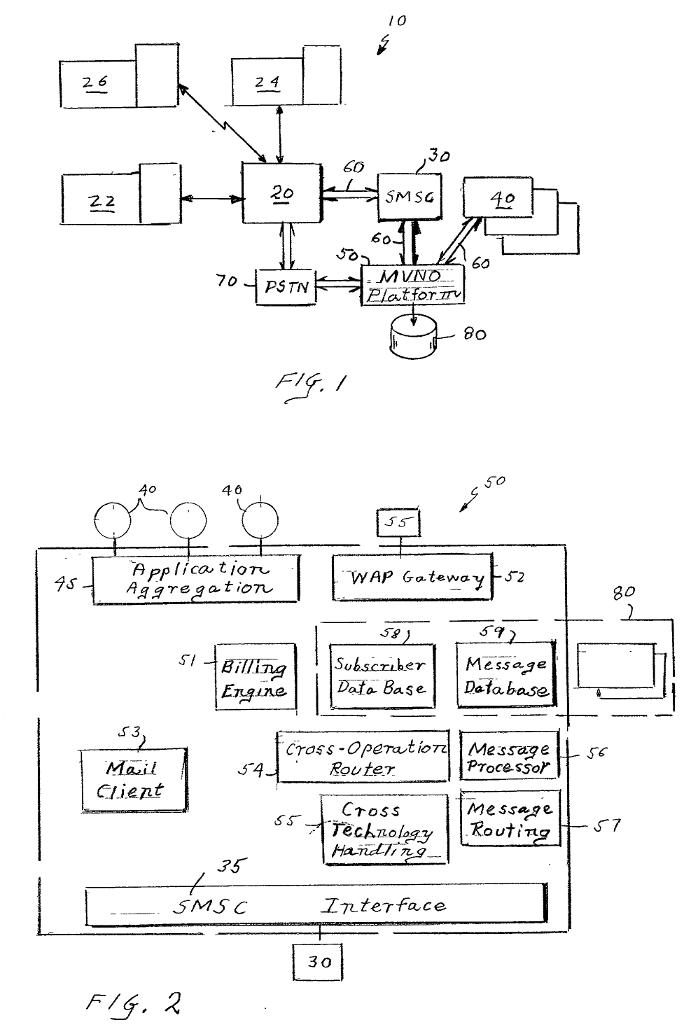

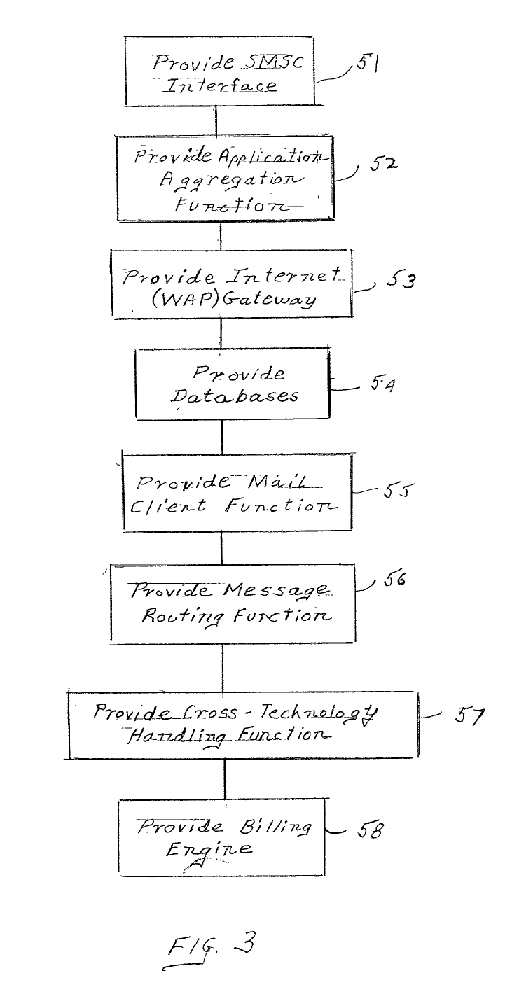

A preferred embodiment of the Mobile Virtual Network Operator (MVNO) platform 50 will now be described referring to FIG. 2. FIG. 2 shows only an illustrative embodiment of the elements of a MVNO platform 50; however, the embodied MVNO platform 50 is not to be taken or construed as being limited thereto. In its broadest terms, the MVNO platform 50 is a “middleware” system that comprises one or more servers (not shown), e.g., microprocessors with memory, as well as a plurality of software processes. More preferably, the MVNO platform 50 comprises a Short Message Peer to Peer (SMPP) protocol proxy server. To an SMPP application, the platform 50 appears to be and functions substantially as a PCS carrier's SMSC 30. However, to the PCS carrier's actual SMSC 30, the platform 50 appears to be and functions substantially as an application.

Preferably, the MVNO platform 50 includes an application aggregation function 45, which includes a microprocessor and memory, e.g., ROM and RAM. The application aggregation function 45 is configured and arranged to host, i.e., aggregate, a plurality of wireless data applications 40 from one or more wireless application operators concurrently. In this manner, remote users 22, 24 and 26 can access any of the wireless data applications 40 that are hosted by the function 45. More preferably, a plurality of wireless application operators provides remote users 22, 24 and 26 with a multiplicity of wireless data applications 40 using the same or a different wireless networks. Heretofore, remote users 22, 24 and 26 could only access wireless data applications 40 that were offered by a wireless application operator on a single wireless network. Thus, the application aggregation function 45 makes it possible for remote users 22, 24 and 26 to access potentially limitless wireless data applications regardless of the network protocol.

The application aggregation function 45 is further configured and arranged to manage data streams to and from the wireless data applications 40. Streaming is a data transferring technique in which data is transferred and processed in a steady, continuous stream. Thus, data can be displayed as it arrives without having to receive the entire data file first. Preferably, the application aggregate function 45 also can be configured and arranged to convert data into streaming Internet Protocol (“IP”). For example, the application aggregate function 45 receives data, e.g., from one of the wireless application operators, and retransmits it to the remote users 22, 24 and 26 in a steady stream. If the remote users 22, 24 and 26 cannot receive data as quickly as it is sent by the wireless application operators, then the excess data can be stored temporarily, e.g., in a buffer, in the application aggregation function 45 until the remote users 22, 24 and 26 can handle the excess.

According to another embodiment of the present invention, wireless application operators that communicate with the MVNO platform 50 can continue to provide wireless data applications 40 using existing hardware and software over existing wireless networks. The application aggregate function 45 further aggregates the multiplicity of wireless data applications 40 regardless of the incompatibility of the various wireless networks, providing remote users 22, 24 and 26 with a plurality of wireless data applications 40 on a seemingly universal wireless network.

Preferably, the MVNO platform 50 further includes an Internet and wireless access protocol (WAP) gateway function 52. WAP is a secure specification, which enables remote users 22, 24 and 26 virtually instantaneous access to data. The gateway function 52, which is a functional node comprising a microprocessor and memory, receives incoming data, e.g., from the Internet 55, that is formatted in a first language, e.g., hyper-text mark-up language (HTML), wireless mark-up language (WML) and the like, and reformats the data to any desired second language, e.g., ASCII, extensible mark-up language (XML), and the like. This enables remote users 22, 24 and 26 that are constrained by the lack of substantial memory to run microbrowsers to access the Internet.

For example, incoming data from the Internet 55 comes into the Internet and WAP gateway function 52 in HTML. The gateway function 52 reformats the data, e.g., into XML, which is more suitable for use with small, hand-held remote devices. The MVNO platform 50 then can transmit the reformatted data to one or more remote users 22, 24, and 26. The opposite is also true. For example, the gateway function 52 of the MVNO platform 50 can receive incoming data, e.g., a request from a wireless device 26, that is formatted in a first language, e.g., ASCII, XML, and the like, and can convert the data to a second language, e.g., HTML, WML, and the like. Once incoming data has been reformatted, the MVNO platform 50 can either respond to the request if it already has accessed the desired data or, alternately, it can transmit the request to any uniform resource locator (URL) address on the Internet 55 and the Web server associated with that URL address will provide the response.

In another embodiment of the present invention, the MVNO platform 50 further includes a hosting function for one or more wireless electronic mail (email) providers 53. The mail client hosting function 53 preferably comprises off-the-shelf software of a type that is well known in the art for providing an interface with email and email service providers.

The mail client hosting function 53 is configured and arranged to (i) enable telematic units 24 and wireless devices 26 to create, send, and receive short data messages; (ii) save undelivered or non-accessed email in a message database 59 provided therefor, (iii) forward undelivered or non-accessed email to telematic units 24 and/or wireless devices 26 on demand; and (iv) forward unsolicited notification that undelivered or non-accessed email is being stored in the message database 59 of the MVNO platform 50 to telematic units 24 and wireless devices 26.

Preferably, the MVNO platform 50 also comprises a cross-operator, or inter-carrier exchange (ICX), router 54 in combination with a cross-technology handling function 55. The cross-operator router 54, which comprises a microprocessor and memory, is a message router that switches messages from one PCS carrier to another PCS carrier based on the destination identifier contained in the incoming data. The cross-technology handling function 55, which essentially comprises a source-code based algorithm on a piece of software or hardware, and router 54 are configured and arranged to enable the exchange of voice and data messages between remote users 22, 24 and 26 who subscribe to any one of a plurality of PCS carriers. More preferably, the cross-technology handling function 55 and router 54 are configured and arranged to provide common messaging between subscribers having different PCS carriers and different air interfaces.

In yet another embodiment of the present invention, the MVNO platform 50 further comprises a message processor 56 and a message routing function 57. The message routing function 57 essentially comprises a source-code based algorithm and driver program that is stored, e.g., on a piece of software or hardware. The message processor 56 is driven by the message routing function 57 and is of a type that is well known to the art. The message processor 56 is configured and arranged to read or scan every incoming message to ascertain whether or not the incoming message contains appropriate content to trigger transmission of a short notification message to a remote unit 22, 24, and 26. Preferably, the message processor 56 searches the text of the message for one or more keywords. Keywords can come from a general library of keywords, which is stored in memory 80, or, alternately, discrete users can generate their own, user-specific keyword libraries, which libraries likewise can be stored in memory 80. Accordingly, when the message processor 56 detects or identifies one or more keywords in the text of an incoming message, the message processor 56 automatically transmits the message to the SMSC 30 for transmission to the appropriate remote unit 22, 24, and 26.

Typically, “short messages” comprise fewer than about 160 characters. Accordingly, in a preferred embodiment, the message processor 56 automatically crops the message into message blocks comprising 160 characters or less. For example, the message processor 56 would transmit an incoming message containing 480 characters in three stages of 160 characters each.

Furthermore, the message routing function 57 is configured and arranged to enable the MVNO platform 50 to transmit messages from remote users 22, 24, and 26 to the appropriate wireless application 40. If delivery of a message is unsuccessful, the message routing function 57 ensures that the MVNO platform 50 automatically stores the message in a message database 59 provided therefor and, moreover, provides the remote user 22, 24, and 26 through the SMSC 30 with notification that an undelivered or non-accessed message is being stored in the message database 59.

In another embodiment of the present invention, the MVNO platform 50 can include a plurality of databases 80. One such database, comprises a subscriber database 58, which can be included or stored in the random access memory (RAM) or read-only memory (ROM) associated with at least one microprocessor. The subscriber database 58 is configured and arranged to store the identities of all subscribers to the system 10. For example, the subscriber database 58 can include at least one of subscriber's names, personal identification numbers, passwords, passphrases, and the like. The subscriber database 58 also can include a security algorithm or other similar alternative security measures that are well known to the art to enable the server to verify the identity of a subscriber.

Several uses of the message database 59 have been described previously in this disclosure. Preferably, an additional function of the message database 59 is to store all incoming messages for archiving data for subscribers, e.g., work orders, billing data, and the like. As a result, subscribers can access such information at any time. Moreover, third parties can use the information for demographic and/or statistical studies.

In a preferred embodiment, the MVNO platform 50 further comprises a billing engine 51. Preferably, in general terms, the billing engine 51 tracks, e.g., counts and times, the number and duration of messages and/or calls (collectively “calls”) flowing through the MNVO platform 50. Heretofore, the PCS carriers and wireless application providers had to provide their own billing engines. The billing engine 51 in the MVNO platform 50 makes these other billing engines redundant because it can be configured and arranged to track all calls, e.g., for billing and reverse billing purposes, and provide the billing information to each of the PCS carriers and wireless application operators.

In more specific terms, the billing engine 51, which comprises a microprocessor and memory, is configured and arranged to create data records of all calls. Such data records can be used to provide billing to users as well as to the PCS carriers, i.e., reverse billing. Furthermore, the billing engine 51 can be configured and arranged to provide multiple tariffs for various subscribers. In this manner, the MVNO platform 50 can eliminate the need of the various PCS carriers to have their own billing engine.

Another important advantage of the MVNO platform 50 is the SMSC interface 35, which is a gateway interface. Indeed, the SMSC interface 35, which comprises a microprocessor and memory, enables the MVNO platform 50 to communicate with one or more PCSs 20 via the SMSC 30. In a preferred embodiment of the present invention, the one or more PCSs 20 can use similar or dissimilar air interface protocols. Accordingly, the SMSC interface 35 is capable of converting communication originating from, e.g., a user of one PCS 20 having a first air interface protocol, or a call originating from the PSTN 70, to a format that is compatible with a different, second air interface protocol of the user called.

A discussion of a method of providing a plurality, or more preferably a multiplicity, of wireless applications offered by one or more wireless application operators to users of one or more personal communication systems will now be described referring to the flow chart in FIG. 3. Indeed, the method comprises the steps of providing a SMSC interface that enables the MVNO platform to communicate with the users of one or more PCS networks through one or more SMSC's using one or more air interface access techniques S1; and providing an application aggregation device that enables the MVNO platform to communicate with one or more wireless application operators, further enabling the network operator platform to provide one or more wireless applications to a plurality of remote user units S2. Accordingly, remote users can communicate with wireless application operators regardless of the wireless network and regardless of the air interface access techniques used by their PCS.

In another aspect of the present invention, the method further comprises the step of providing an Internet gateway that converts and reformats a first text or binary language to a second text or binary language to enable communication of data information between the plurality of remote user units and one or more Internet Service Providers S3.

In yet another aspect of the present invention, the method further comprises the steps of providing one or more databases S4, wherein said one or more databases comprises at least one of a message database and a subscriber database; providing a mail client function S5 for use as described above; providing a message routing function S6 for use as described above; providing a cross-technology handling function S7 for use as described above; and providing one or more billing engines S8 for use as described above.

Although the present invention has been as described in detail with reference to its preferred embodiments, it should be readily apparent to those skilled in the art that changes and modifications in form and details can be made without departing from the scope and spirit of this disclosure.

For example, although the specification has described network communication where the network is a PCS, the network should not be taken or construed as limited thereto. Indeed, in alternate embodiments, the network can be a special mobile radio (SMR) network, a cellular network or an iDEN wireless network.

What is claimed is:

1. A system for providing one or more personal communication systems, operating using one or more air interface protocols carriers, with a plurality of wireless applications from one or more wireless application operators, the system comprising:
a network, having a plurality of system interconnections; and
a mobile virtual network operator platform;
wherein the mobile virtual network platform comprises:
one or more short message service centers;
a short message service center interface that enables the network operator platform to communicate with the one or more personal communication system carriers through the one or more short message service centers using one or more air interface access techniques; and
an application aggregation device that enables the network operator platform to communicate with said one or more wireless application operators, further enabling the network operator platform to provide one or more wireless applications to a plurality of remote user units through one or more personal communications system.

2. The system as recited in claim 1, wherein the network comprises one or more personal communication networks.

3. The system as recited in claim 2, wherein the network further comprises a plurality of devices selected from the group consisting of remote wireless units, telematic units, and telemetry units.

4. The system as recited in claim 1, wherein the one or more air interface standards comprises a standard selected from the group consisting of global standards for mobile communications (GSM), time division multiplexing access (TDMA), frequency division multiplexing access (FDMA), code division multiplexing access (CDMA), and integrated digital enhanced network (iDEN).

5. The system as recited in claim 1, wherein the network can communicate with a network selected from the group consisting of a Personal Communication System (PCS) network, a Cellular network, a Special Mobile Radio (SMR) network, and an iDEN wireless network.

6. The system as recited in claim 5, wherein the mobile virtual operator network platform can communicate with one or more users of at least one network selected from the group consisting of a Personal Communication System (PCS) network, a Cellular network, a Special Mobile Radio (SMR) network, and an iDEN wireless network.

7. The system as recited in claim 1, wherein the system further comprises a short message service center that communicates with at least one of the wireless application operators and at least one personal communication system (PCS) carrier via a short message service center interface.

8. The system as recited in claim 7, wherein the short message service center can communicate with multiple wireless application operator operating on at least one of similar and dissimilar wireless networks.

9. The system as recited in claim 7, wherein the short message service center communicates with the at least one PCS carrier via the mobile virtual network operator platform.

10. The system as recited in claim 1, wherein the mobile virtual network operator platform communicates with one or more databases.

11. The system as recited in claim 1, wherein the system further comprises a public switched telephone network that is in communication with the network.

12. A mobile virtual network operator platform for providing a plurality of wireless applications from one or more wireless application operators to one or more personal communication system carriers, the network operator platform comprising:
one or more short message service centers;
a short message service center interface, comprising a microprocessor and memory, that enables the network operator platform to communicate with the one or more personal communication system carriers through the one or more short message service centers using one or more air interface access techniques; and
an application aggregation device, comprising a microprocessor and memory, that enables the network operator platform to communicate with said one or more wireless application operators, further enabling the network operator platform to provide one or more wireless applications to a plurality of remote user units through one or more personal communications system.

13. The network operator platform as recited in claim 12, wherein the network operator platform further comprises an Internet wireless access protocol gateway that converts and reformats a first text language to a second text language to enable communication of data information between the plurality of remote user units and one or more Internet Service Providers.

14. The network operator platform as recited in claim 12, wherein the network operator platform further comprises an Internet wireless application protocol gateway that converts and reformats a first binary language to a second binary language to enable communication of data information between the plurality of remote user units and one or more Internet Service Providers.

15. The network operator platform as recited in claim 12, wherein the plurality of remote user units is selected from the group consisting of remote wireless units, remote telematic units, and remote telemetry units.

16. The network operator platform as recited in claim 12, wherein the network operator platform further comprises:
one or more databases, wherein said one or more databases comprises at least one of a message database and a subscriber database;
a mail client function that enables remote user units to communicate with other remote user units by way of electronic mail services;
a message processor that reads all messages coming into said network operator platform; and
a cross-operator router that enables transmission of at least one of voice and data messages even if transmission requires formatting said at least one of voice and data messages into a second air interface protocol.

17. The network operator platform as recited in claim 16, wherein the message processor includes a message routing function, whereby a plurality of messages is routed to the destined PCS carrier.

18. The network operator platform as recited in claim 16, wherein the cross-operator router includes a cross-technology handling function, whereby a plurality of messages can be delivered to the destined PCS carrier.

19. The network operator platform as recited in claim 12, wherein the network operator platform further comprises at least one billing engine.

20. A method of providing a plurality of wireless applications from one or more wireless application operators to one or more personal communication system carriers, the method comprising the steps of:
providing a virtual mobile network operator platform;
providing a short message service center interface, comprising a microprocessor and memory, that enables said network operator platform to communicate with the one or more personal communication system carriers through one or more short message service centers using one or more air interface access techniques; and
providing an application aggregation device, comprising a microprocessor and memory, that enables said network operator platform to communicate with said one or more wireless application operators, further enabling the network operator platform to provide one or more wireless applications to said one or more personal communication system carriers.

21. The method as recited in claim 20, wherein the method further comprises the step of providing an Internet wireless access protocol gateway that converts and reformats a first text language to a second text language to enable communication of data information between said one or more personal communication system carriers and one or more Internet Service Providers.

22. The method as recited in claim 20, wherein the method further comprises the step of providing an Internet wireless access protocol gateway that converts and reformats a first binary language to a second binary language to enable communication of data information between said one or more personal communication system carriers and one or more Internet Service Providers.

23. The method as recited in claim 20, wherein the method further comprises the steps of:
providing one or more databases, wherein said one or more databases comprises at least one of a message database and a subscriber database;
providing a mail client function;
providing a message routing function; and
providing a cross-technology handling function.

24. The method as recited in claim 20, wherein the method further comprises the step of providing one or more billing engines.

25. A method of providing a plurality of wireless applications from one or more wireless application operators to one or more remote users of one or more personal communication systems, the method comprising the steps of:
providing a virtual mobile network operator platform;
providing a short message service center interface, comprising a microprocessor and memory, that enables said network operator platform to communicate with said one or more remote users of said one or more personal communication systems through one or more short message service centers using one or more air interface access techniques; and
providing an application aggregation device, comprising a microprocessor and memory, that enables said network operator platform to communicate with said one or more wireless application operators, further enabling the network operator platform to provide one or more wireless applications to one or more remote users of said one or more personal communication systems.

26. The method as recited in claim 25, wherein the method further comprises the step of providing an Internet wireless application protocol gateway that converts and reformats a first text language to a second text language to enable communication of data information between said one or more remote users of said one or more personal communication system carriers and one or more Internet Service Providers.

27. The method as recited in claim 25, wherein the method further comprises the step of providing an Internet wireless access protocol gateway that converts and reformats a first binary language to a second binary language to enable communication of data information between said one or more remote users of said one or more personal communication system carriers and one or more Internet Service Providers.

28. The method as recited in claim 25, wherein the method further comprises the steps of:
providing one or more databases, wherein said one or more databases comprises at least one of a message database and a subscriber database;
providing a mail client function;
providing a message routing function; and
providing a cross-technology handling function.

29. The method as recited in claim 25, wherein the method further comprises the step of providing one or more billing engines.
